(19) United States
(12) Patent Application Publication
(10) Pub. No.: US 2002/0038155 A1
(43) Pub. Date: Mar. 28, 2002

(54) System and method for sequence control

(76) Inventors: Masaru Takada, Yokohama-shi (JP); Masataka Tsuji, Machida-shi (JP); Takuo Takano, Fujisawa-shi (JP)

Correspondence Address: PILLSBURY WINTHROP LLP, 1600 TYSONS BOULEVARD, MCLEAN, VA, 22102, US

(21) Appl. No.: 09/960,966

(22) Filed: Sep. 25, 2001

(30) Foreign Application Priority Data
Sep. 26, 2000 (JP) 2000-292616

(51) Int. Cl. G05B 11/01; G05B 19/18

(52) U.S. Cl. 700/11; 700/18; 700/2

(57) ABSTRACT

To be readily adaptable to all sorts of control modes, including process suspend and resume, and reverse sequence control, a series of processes is divided into a plurality of steps, and the substance of the processing performed by each step is defined as a processing unit. Each time a processing unit runs, the system looks up a run process information area in which process information has been recorded, and runs the next processing unit specified there. Also, each time a processing unit runs, the process information is updated with information relating to the next processing unit to be run.

### BACKGROUND OF THE INVENTION

1. Field of the Invention

The present invention relates to sequence control. In particular, it relates to a system and method for sequence control, and to a recording medium in which a sequence control program has been recorded.

The present invention is a novel proposal relating to sequence control which will make it easier to create and maintain sequence control programs. The invention also relates to resuming and continuing to run a sequence after the sequence has been suspended, and to running a sequence backwards.

2. Description of Related Art

A control system that uses software requires a control program for indicating control procedures to the sequence control system. A known method of writing such a control program is to divide a series of processes in time series fashion into a plurality of steps, and to use flowcharts that indicate the process content of each step.

For example, a series of processes is divided into steps A, B, C, D and E, each of which performs a process with a respective objective. These steps are controlled as follows: when step A is completed, the control flow advances to step B, and when step B is completed, it advances to step C. A control method of this sort is called sequential control.

In this conventional sequential control, process contents and procedures are changed by rewriting the flowcharts. A flowchart from “START” to “END” is a series of control procedures, and one way that these control procedures can be changed is to switch between a plurality of flowcharts that have been provided in advance.

Consider the introduction, in a conventional flowchart-based sequential control system of this sort, of a control procedure for suspending processing at an arbitrary stage and then resuming the processing. To implement such a control procedure would for example require a program that 1) provides, at each process step, a step for confirming whether or not there is a suspend instruction, 2) provides a separate flowchart at a place to which the control flow jumps when a suspend instruction is received, 3) provides, in this separate flowchart, a step for confirming whether or not there is a resume instruction, and 4) returns to a specified position in the original flowchart when it has received a resume instruction.

Alternatively, consider the introduction, in a conventional flowchart-based sequential control system of this sort, of a control procedure for reversing a process at an arbitrary stage. To implement such a control procedure would for example require a program that 1) provides, at each process step, a step for confirming whether or not there is a reversal instruction, 2) provides a separate flowchart at a place to which the control flow jumps when a reversal instruction is received, 3) provides, for this separate flowchart, a program for running the steps that are the reverse of the aforementioned steps, 4) provides a step for confirming whether or not there is a return instruction, and 5) returns to a specified position in the original flowchart when it has received a return instruction.

Thus a conventional sequential control system requires the provision of a complicated program in order to suspend and resume a series of processes, and to perform reverse sequence control.

### SUMMARY OF THE INVENTION

The present invention has been devised in the light of this situation. It is an object of the invention to provide a system and method for sequence control, and a recording medium, that are readily adaptable to all sorts of control modes, including process suspend and resume, and reverse sequence control.

In this invention, a series of processes is divided into a plurality of steps, and the substance of the processing performed by each step is defined as a processing unit. Each time a processing unit runs, the system looks up a run process information area in which process information has been recorded, and runs the next processing unit specified there. Also, each time a processing unit runs, the process information is updated with information relating to the next processing unit to be run. Namely, a feature of this invention is that each time a processing unit runs, the next process is confirmed by returning to the run process information area. As a result, the control procedures indicated by a control program can easily be changed by rewriting the process information in the run process information area.

As well as recording process information in a run process information area, resume process information can be written in a resume process information area. This resume process information indicates which processing unit to run if the sequence is to be resumed after a currently running processing unit is suspended. The provision of resume process information makes it clear which processing unit the processing should start from when resuming after a processing unit has been suspended while running, which means that resuming is performed rapidly.

In addition, reverse process information can be written in a reverse process information area. When it is desired to cause a currently running sequence to proceed in the reverse direction, by issuing a command to this effect, the reverse process information enables the run process information to be written and read in the reverse order, thereby enabling the reverse sequence to be rapidly executed. This simplifies the extensive changes of control procedure that are involved in reverse sequence control.

The following description may make this invention easier to understand. Namely, introducing the concept of a processing unit indicative of the content of a process, and dealing separately with this processing unit and the process information indicative of the processing order, makes it easier to create a program for suspending and resuming a process, and for performing reverse sequence control. This invention also introduces an hierarchical structure among processing units and subdivides processing units, whereby it can cope with both small-scale and large-scale changes in control procedure.

According to a first aspect, the present invention is a sequence control system having the following features:

a) a sequence program is expressed as a series of processing units, each comprising input and output of information, decisions and calculations;

b) for each processing unit, the processing unit to be run next is specified as run process information;

c) there is provided, in a memory area, a run process information area that can be looked up by all processing units, and which, each time a processing unit finishes running, is updated with the aforementioned run process information specified by that processing unit;

d) there is provided means for looking up the run process information area when a processing unit finishes running, and means whereby the processing unit specified in this run process information area starts running.

Preferably, a sequence control system according to the present invention comprises:

a) in addition to run process information, resume process information for specifying the processing unit from which the sequence is to be resumed after being suspended;

b) a resume process information area for storing, in the aforementioned memory area, resume process information;

c) means which, when a sequence is to be resumed after that sequence has been suspended, rewrites the processing unit in the run process information area with the processing unit specified in the resume process information area, and runs the processing unit specified by the resume process information.

Preferably, a sequence control system according to the present invention comprises:

a) a reverse sequence program for running a sequence that is the reverse of a given sequence;

b) reverse process information for specifying a processing unit of the aforementioned reverse sequence program, when running a reverse sequence;

c) a reverse process information area for storing, in the aforementioned memory area, the reverse process information for specifying a processing unit when running the aforementioned reverse sequence;

d) means for running the reverse sequence processing unit specified in the reverse process information area, when running the given sequence in reverse.

According to a second aspect, the present invention is a sequence control method comprising:

a) constructing a sequence program as a series of processing units, each comprising input and output of information, decisions and calculations;

b) specifying, for each processing unit, the processing unit to be run next; and

c) running this specified processing unit.

Preferably, a sequence control method according to this invention comprises:

a) for each processing unit, in addition to specifying the processing unit to be run next as run process information, specifying the processing unit to be run after sequence suspension as resume process information;

b) for normal running, running the processing unit specified by the aforementioned run process information; and for resuming after sequence suspension, running the processing unit specified by the resume process information.

Preferably, a sequence control method according to this invention also comprises:

a) for each processing unit, in addition to specifying the processing unit to be run next in normal sequence processing, including reverse process information for specifying the next processing unit when running a sequence in the opposite direction to normal running;

b) in normal sequence running, running the processing unit specified by the run process information, and when running the reverse sequence, running the reverse sequence processing unit that is specified by the reverse process information.

According to a third aspect, this invention is a recording medium in which a sequence program has been recorded, wherein:

a) the sequence program is divided into a plurality of processing units, each comprising input and output of information, decisions and calculations;

b) for each processing unit, the processing unit to be run next is specified as run process information;

c) the sequence program runs the processing unit specified by the run process information.

Preferably, a recording medium according to this invention is one in which a sequence program has been recorded, wherein:

a) for each processing unit, the processing unit to be run next is specified as run process information, and additionally, the processing unit to be run after sequence suspension is specified as resume process information;

b) for normal sequence running, the sequence program runs the processing unit specified by the run process information, and for resuming after sequence suspension, the sequence program runs the processing unit specified by the resume process information.

Preferably, a recording medium according to this invention is one in which a sequence program has been recorded, wherein:

a) for each processing unit, the processing unit to be run next in normal sequence processing is specified, and there is also provided a reverse sequence in which is specified the next processing unit when running a sequence in the opposite direction to normal running;

b) in normal sequence running, the sequence program runs the processing unit specified by the run process information, and when running the reverse sequence, the sequence program runs the reverse sequence processing unit specified by the reverse process information.

### BRIEF DESCRIPTION OF THE DRAWINGS

Specific embodiments of the present invention will now be described, by way of example only, with reference to the accompanying drawings in which:

FIG. 1 is a block diagram of a sequence control system according to an embodiment of the invention.

FIG. 2 serves to explain the processing units.

FIG. 3 shows the hierarchical structure of the processing units.

FIG. 4 shows a sequence model serving to explain the action level.

FIG. 5 shows a sequence flow serving to explain the action level.

FIG. 6 shows an example of a program at the action level.

FIG. 7 shows an example of a program at the block level.

FIG. 8 shows an example of a program at the step level.

FIG. 9 shows an example of a program at the instruction level.

FIG. 10 shows the correspondence between the configuration of a processing unit according to this embodiment and the flow of a sequence.

FIG. 11 serves to explain the control of sequence progression.

FIG. 12 shows a specific control system.

FIG. 13 is a flowchart for the control of sequence progression in the specific control system.

FIG. 14 serves to explain the control involved in suspending and resuming a sequence.

FIG. 15 shows an example of a situation where there are a plurality of sequences.

FIG. 16 serves to explain the control of sequence progression that can include control of sequence suspend and resume.

FIG. 17 shows an example of a sequence that has been suspended.

FIG. 18 shows an example of a sequence that is to be resumed after being suspended.

FIG. 19 serves to explain the control of sequence progression where the sequence can run both forwards and backwards.

### DETAILED DESCRIPTION OF THE PREFERRED EMBODIMENTS

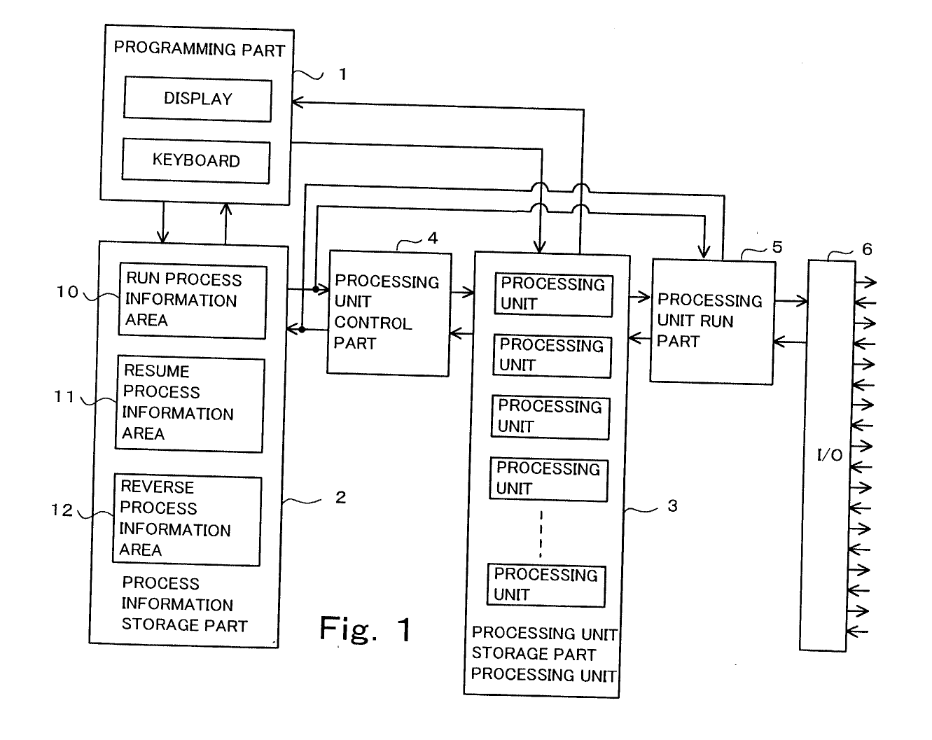

A sequence control system according to an embodiment of the present invention will be described with reference to FIG. 1, which is a block diagram of such a sequence control system.

As shown in FIG. 1, in a sequence control system according to an embodiment of this invention: a sequence program is stored in processing unit storage part 3, said sequence program being expressed as a sequence of processing units each comprising input and output of information, decisions and calculations; for each processing unit, the processing unit to be run next is specified as run process information; there is provided, in a memory area of process information storage part 2, a run process information area 10 that can be looked up by all processing units, and which, each time a processing unit finishes running, is updated by the aforementioned run process information specified by that processing unit; processing unit control part 4 looks up run process information area 10 when a processing unit finishes running; and processing unit run part 5 starts running the processing unit specified by this run process information area 10.

In addition to run process information area 10, process information storage part 2 is also provided with resume process information area 11 for storing, in the aforementioned memory area, resume process information for specifying the processing unit from which a sequence is to be resumed after being suspended. When a sequence is to be resumed after that sequence has been suspended, processing unit control part 4 rewrites the processing unit in run process information area 10 with the processing unit specified in resume process information area 11. Processing unit run part 5 then runs the processing unit specified by this resume process information.

Process information storage part 2 is also provided with reverse process information area 12 for storing, in the aforementioned memory area, reverse process information for specifying a processing unit of a reverse sequence program when a reverse sequence is to be run; and when a sequence is to be run in reverse, processing unit run part 5 runs the reverse sequence processing unit specified in reverse process information area 12.

A sequence control system according to this embodiment of the invention operates as a system whereby sequence control is performed as a result of a programmer using programming part 1 to create, in the form of programs, run process information, resume process information and reverse process information within process information storage part 2, and processing units within processing unit storage part 3. The run process information, resume process information and reverse process information in process information storage part 2, and the processing units in processing unit storage part 3, are recorded in a recording medium. Software is also recorded in the recording medium, and this software, by being installed in a computer device, makes this computer device into a system equivalent to process information storage part 2, processing unit storage part 3, processing unit control part 4, processing unit run part 5 and input/output part 6. By using the recording medium to install these different types of information and software in a computer device, this computer device can be made into a sequence control system according to this embodiment of the invention.

This embodiment of the invention will now be described in greater detail.

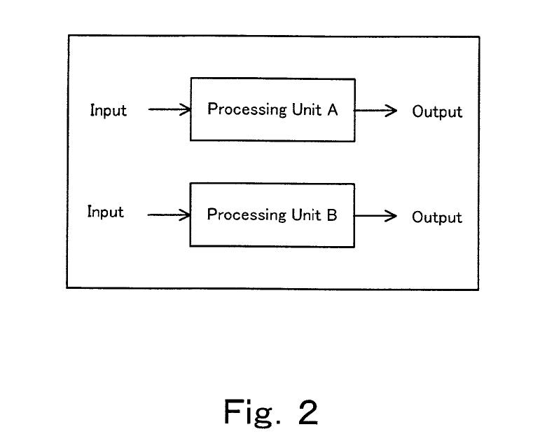

Processing units will be described with reference to FIG. 2. As shown in FIG. 2, processing units A and B each have an input and an output, and each performs decisions or calculations. In this embodiment, it will be assumed that processing units A and B perform different processes, and that if the same processing is to be repeated, the same processing unit is run repeatedly.

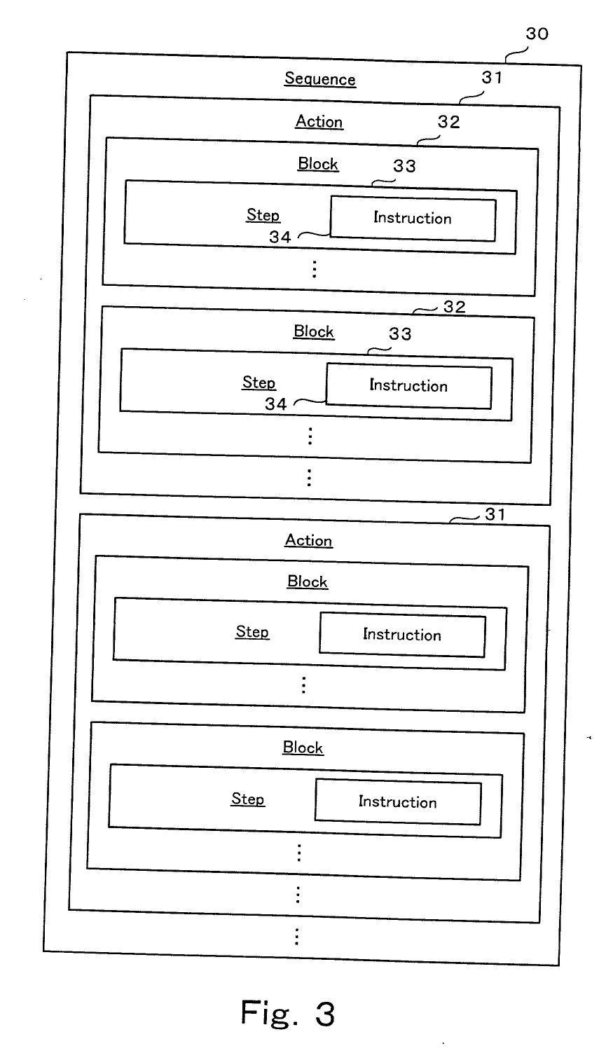

The hierarchical structure of the processing units will be described with reference to FIG. 3, which shows that processing units have hierarchical levels that can be represented as a nested structure. The example of FIG. 3 shows sequence 30 comprising two processing units, wherein each processing unit has action level 31, block level 32 within action level 31, step level 33 within block level 32, and instruction level 34 within block level 32.

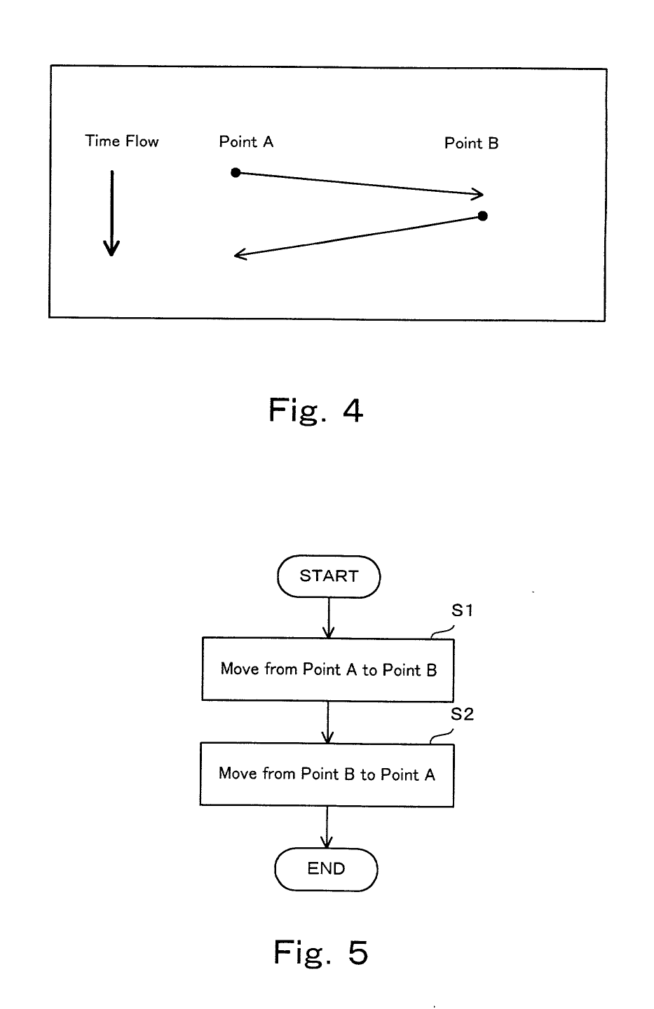

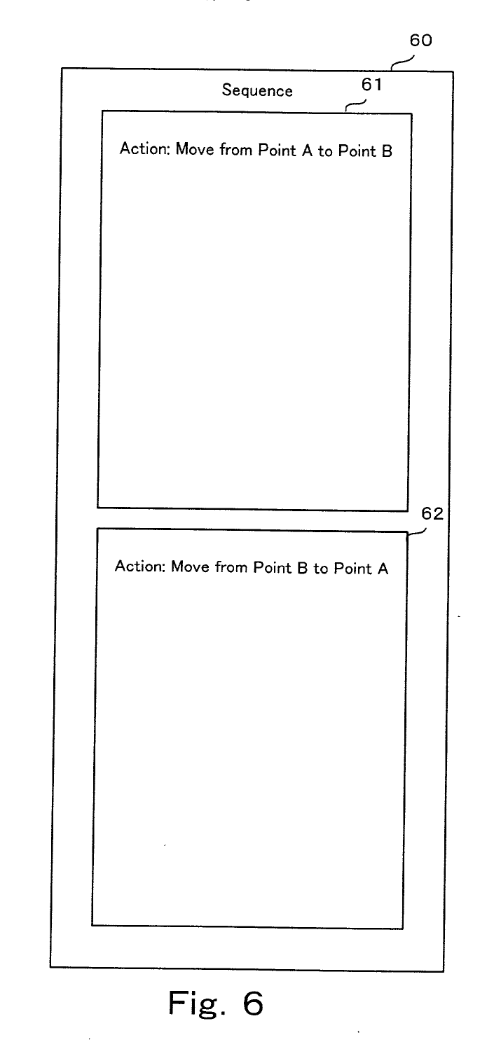

The action level will be described with reference to FIGS. 4, 5 and 6. FIG. 4 shows a sequence model serving to explain the action level. FIG. 5 shows a sequence flow serving to explain the action level. FIG. 6 shows an example of a program at the action level.

The sequence model shown in FIG. 4 is a sequence model for returning to point A (S2 sown in FIG. 5) after moving from point A to point B (S1 shown in FIG. 5). A sequence model of this sort can be divided into parts by looking at the specific operations (which will be called “actions”) that occur in the sequence. In the example shown in FIG. 6, sequence 60 can be expressed as two actions 61 and 62 wherein action 61 is called “move from point A to point B and confirm completion of the operation”, and action 62 is called “move from point B to point A and confirm completion of the operation”.

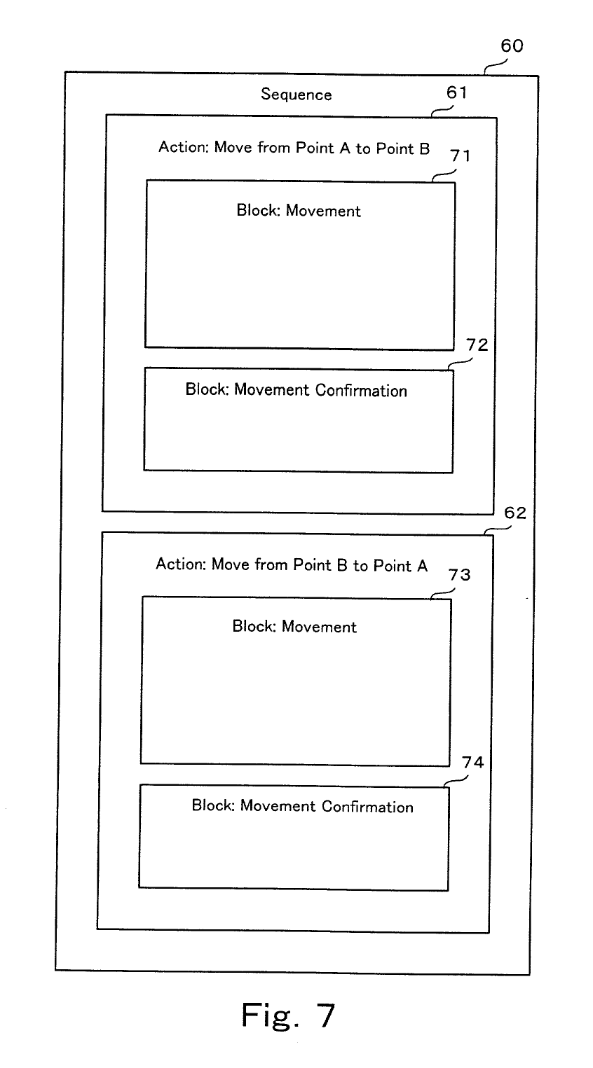

The block level will be described with reference to FIG. 7, which shows an example of a program at the block level. The aforementioned action level can be divided into parts by looking at the specific processes (which will be called “blocks”) that occur in the actions. In the example shown in FIG. 7, actions 61 and 62 can each be expressed as two blocks wherein action 61 is separated into “movement” block 71 and “movement confirmation” block 72 and action 62 is separated into “movement” block 73 and “movement confirmation” block 74.

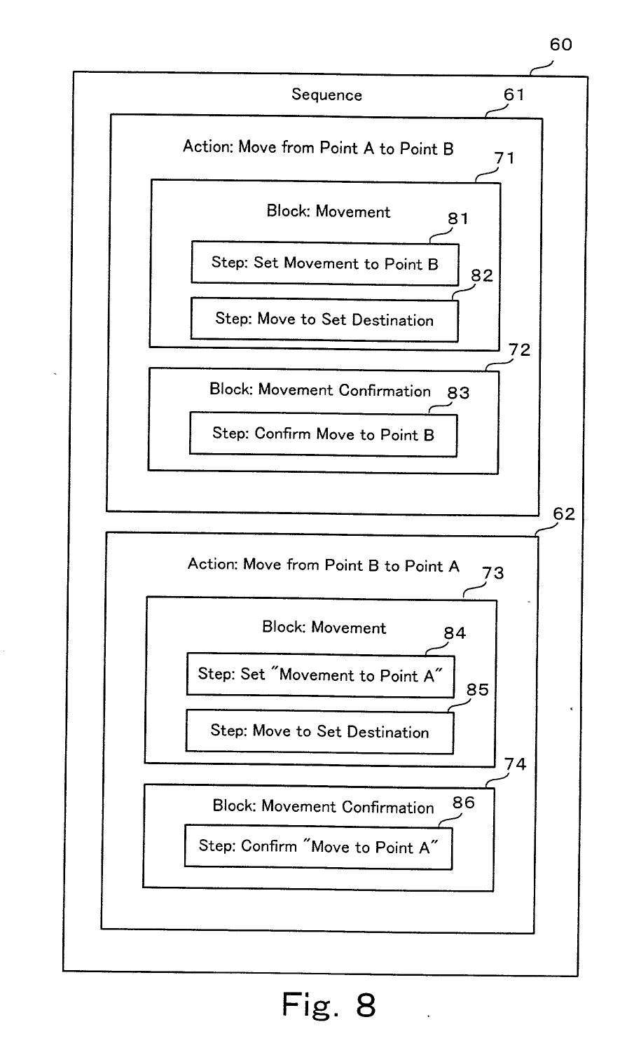

The step level will be described with reference to FIG. 8, which shows an example of a program at the step level. The aforementioned block level can be divided into parts by looking at the specific procedures (which will be called “steps”) that occur in the blocks. In the example shown in FIG. 8, blocks 71, 72, 73 and 74 can each be expressed as steps wherein “movement” block 71 comprises “set the movement to point B” step 81 and “move to the set destination” step 82, while movement confirmation block 72 comprises “confirm movement to point B” step83. Similarly, “movement” block 73 comprises “set the movement to point A” step 84 and “move to the set destination” step 85, while “movement confirmation” block 74 comprises “confirm movement to point A” step 86.

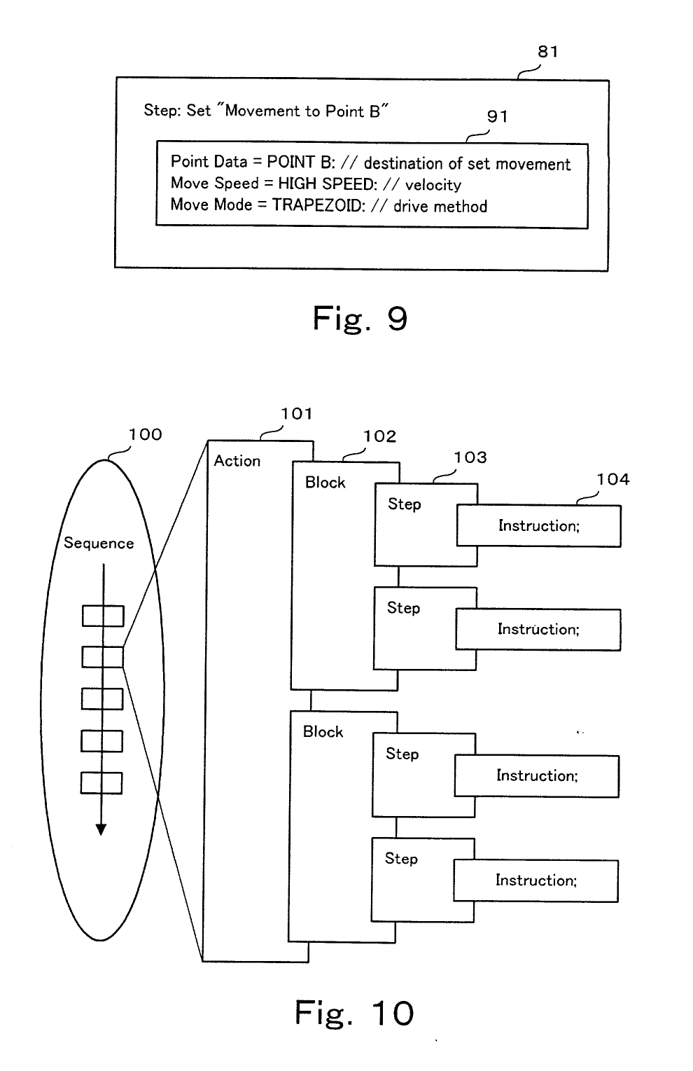

The instruction level will be described with reference to FIG. 9, which shows an example of a program at this level. At the instruction level, a programming language (which will be called the “instruction code”) is used to express the steps that have been set at the step level. As shown in FIG. 9, in the case of “set the movement to point B” step 81, instruction level 91 describes the destination of the movement that has been set, its velocity, and the drive method to be employed.

FIG. 10 shows the correspondence between the configuration of a processing unit according to this embodiment and the flow of a sequence. Serial sequence 100 is divided into a plurality of actions 101, and each action 100 has an hierarchical structure comprising block levels 102, step levels 103 and instruction levels 104. In other words, a serial sequence is divided into a plurality of operations (“actions”) and each operation is further divided into a plurality of processes (“blocks”). Procedures (“steps”) are set for implementing these processes, and these procedures are expressed using a programming language (“instruction code”). As a result, a control program can be created from easy to understand processing units.

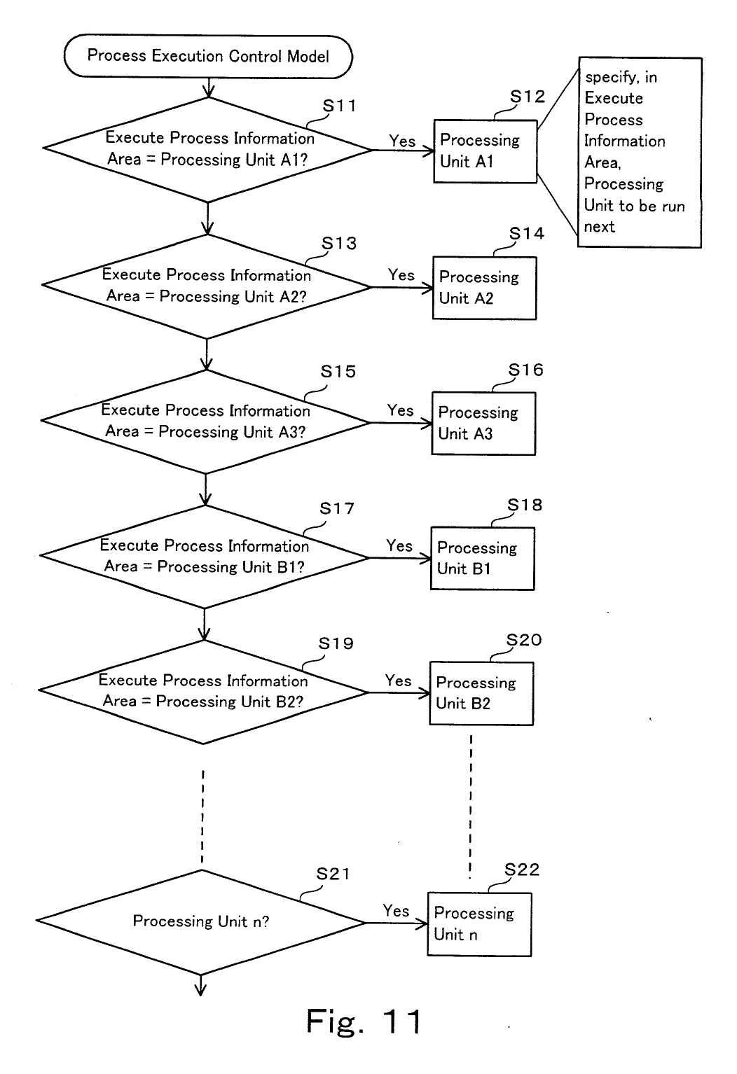

The control of sequence progression will be described with reference to FIG. 11, which shows that sequence progression is controlled as follows. Namely, information relating to the processing unit to be run next is written in each processing unit, and when a processing unit finishes running, processing unit control part 4 rewrites the run process information that is written in run process information area 10, this being the storage area that serves to specify the processing unit to be run next. Processing unit run part 5 looks up run process information area 10, sees the processing unit to be run next (S11, S13, S15, S17, S19 and S21), and runs that processing unit (S12, S14, S16, S18, S20 and S22).

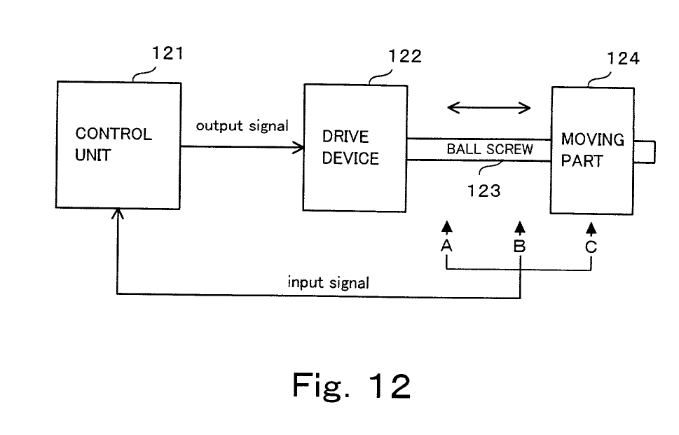

This embodiment of the invention will be described in application to the specific control system shown in FIG. 12, which assumes a task that is controlled by causing a moving part to shift among points A, B and C. The control unit outputs a signal to the drive device to specify the direction of rotation of the ball screw. Input signals for obtaining information regarding the position of the moving part are generated at points A, B and C. By way of an example, a description will be given of causing the moving part to move in order of A, C, B, C and A.

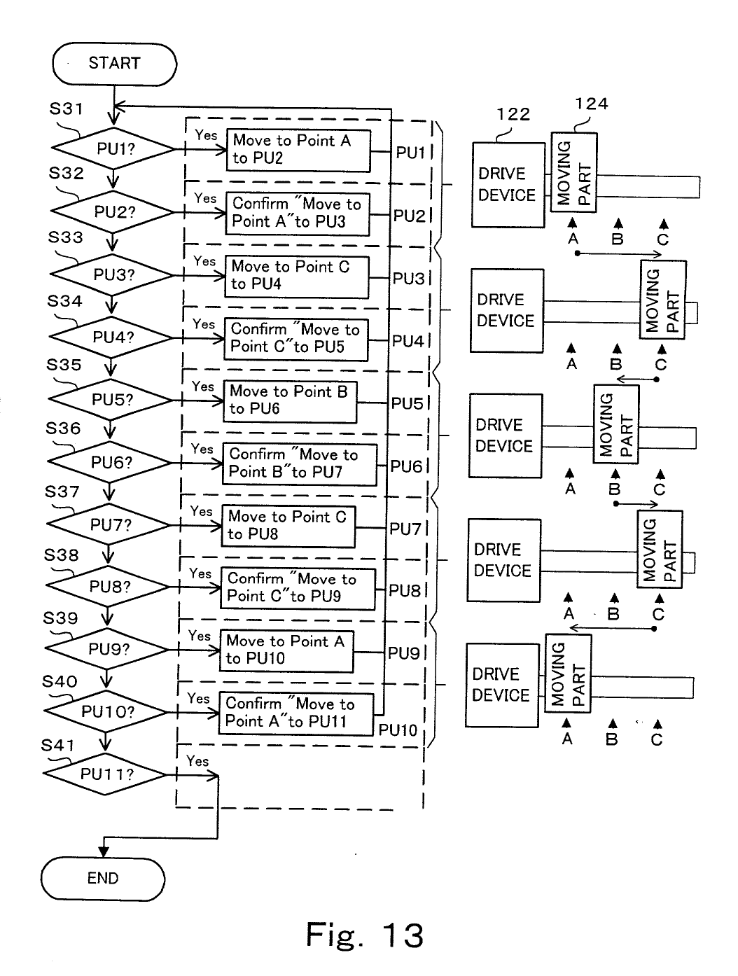

FIG. 13 is a flowchart for controlling sequence progression in the control system depicted in FIG. 12. Processing units PU1 toPU10 are processing units at the aforementioned block level, while processing units PU11+PU2, PU3+PU4, PU5+PU6, PU7+PU8 and PU9+PU10 are processing units at the aforementioned action level. There are also step level processing units contained in the block level processing units, and instruction level processing units contained in the step level processing units, but reference to these units will be omitted from the following description. The control unit of FIG. 12 is provided with a sequence control system according to this embodiment.

When the control unit issues a sequence start instruction, processing unit run part 5 shown in FIG. 1 looks up run process information area 10 in process information storage part 2. At the outset, information to the effect that processing unit PU1 is to be run is recorded in run process information area 10. In accordance with this run process information, the process “move to point A” corresponding to processing unit PU1 is executed (S31). When running of processing unit PU1 is completed, processing unit control part 4 rewrites the run process information written in run process information area 10, which specifies the next processing unit to be run, substituting information relating to processing unit PU2.

In accordance with this rewritten run process information, processing unit run part 5 runs the process “confirm move to point A” corresponding to processing unit PU2 (S32). When running of processing unit PU2 is completed, processing unit control part 4 rewrites the run process information written in run process information area 10, which specifies the next processing unit to be run, substituting information relating to processing unit PU3.

In accordance with this rewritten run process information, processing unit run part 5 runs the process “move to point C” corresponding to processing unit PU3 (S33). When running of processing unit PU3 is completed, processing unit control part 4 rewrites the run process information written in run process information area 10, which specifies the next processing unit to be run, substituting information relating to processing unit PU4.

In accordance with this rewritten run process information, processing unit run part 5 runs the process “confirm move to point C” corresponding to processing unit PU4 (S34). When running of processing unit PU4 is completed, processing unit control part 4 rewrites the run process information written in run process information area 10, which specifies the next processing unit to be run, substituting information relating to processing unit PU5.

In accordance with this rewritten run process information, processing unit run part 5 runs the process “move to point B” corresponding to processing unit PU5 (S35). When running of processing unit PU5 is completed, processing unit control part 4 rewrites the run process information written in run process information area 10, which specifies the next processing unit to be run, substituting information relating to processing unit PU6.

In accordance with this rewritten run process information, processing unit run part 5 runs the process “confirm move to point B” corresponding to processing unit PU6 (S36). When running of processing unit PU6 is completed, processing unit control part 4 rewrites the run process information written in run process information area 10, which specifies the next processing unit to be run, substituting information relating to processing unit PU7.

In accordance with this rewritten run process information, processing unit run part 5 runs the process “move to point C” corresponding to processing unit PU7 (S37). When running of processing unit PU7 is completed, processing unit control part 4 rewrites the run process information written in run process information area 10, which specifies the next processing unit to be run, substituting information relating to processing unit PU8.

In accordance with this rewritten run process information, processing unit run part 5 runs the process “confirm move to point C” corresponding to processing unit PU8 (S38). When running of processing unit PU8 is completed, processing unit control part 4 rewrites the run process information written in run process information area 10, which specifies the next processing unit to be run, substituting information relating to processing unit PU9.

In accordance with this rewritten run process information, processing unit run part 5 runs the process “move to point A” corresponding to processing unit PU9 (S39). When running of processing unit PU9 is completed, processing unit control part 4 rewrites the run process information written in run process information area 10, which specifies the next processing unit to be run, substituting information relating to processing unit PU10.

In accordance with this rewritten run process information, processing unit run part 5 runs the process “confirm move to point A” corresponding to processing unit PU10 (S40). When running of processing unit PU10 is completed, processing unit control part 4 rewrites the run process information written in run process information area 10, which specifies the next processing unit to be run, substituting information relating to processing unit PU11.

In accordance with this rewritten run process information, processing unit run part 5 tries to run the process corresponding to processing unit PU11 (S41), but because there is no processing unit PU11, it recognizes that the sequence has finished.

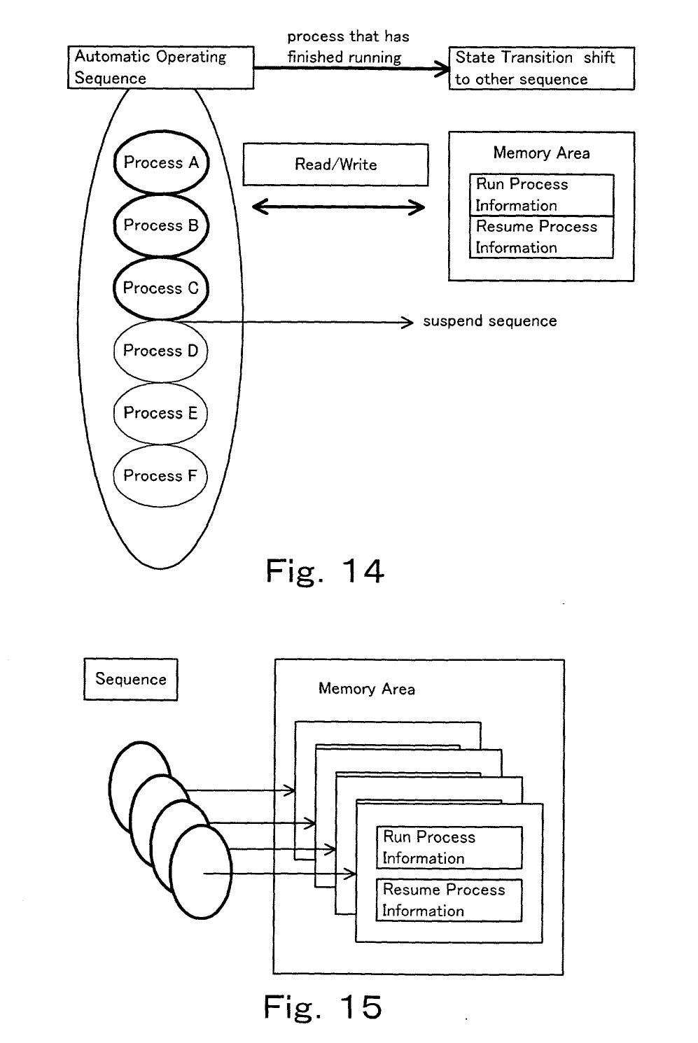

The control involved in suspending and resuming a sequence will be described with reference to FIG. 14. Whereas the control of sequence progression involved providing information that specifies, in advance, the processing unit to be run next, the control required for resuming a sequence after that sequence has been suspended involves providing information that specifies, in advance, the processing unit to which the processing must return when resuming from a state of suspension. The former information is called “run process information” while the latter is called “resume process information”, and these two kinds of process information are respectively written in run process information area 10 and resume process information area 11 of process information storage part 2. If there are a plurality of sequences, as depicted in FIG. 15, a separate memory area is allocated to each sequence, and run process information area 10 and resume process information area 11 are each divided into a plurality of areas.

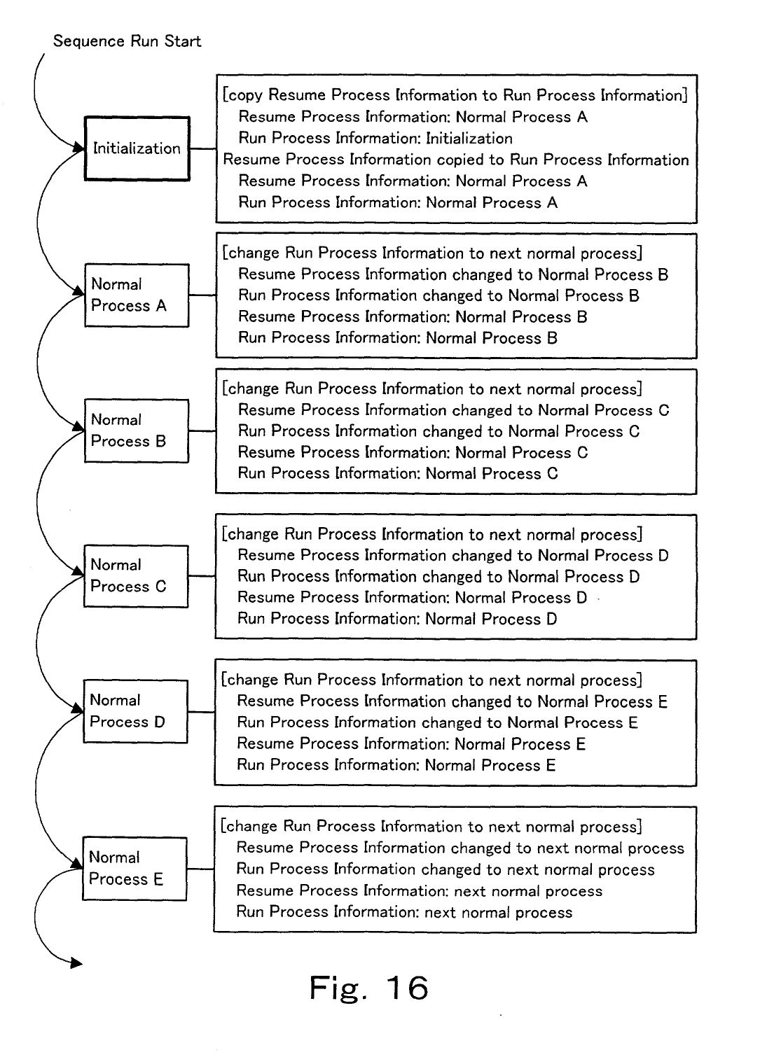

The control of sequence progression that can include control of sequence suspend and resume, will be described with reference to FIG. 16. As shown in FIG. 16, an initialization process is provided, and this is always run at the outset, prior to running the sequence. To move from the initialization process to an ordinary process, the resume process information is transferred (by the initialization) to the run process information. The sequence then progresses, starting from the ordinary process that has been specified as a result of this transfer of information.

The example of FIG. 16 shows the following progression: initialization process, normal process A, normal process B, normal process C, normal process D and normal process E. The initialization process is always run first of all, when the running of the sequence is to be started. In the initialization process, normal process A is written in advance as the resume process information, and the initialization process is written as the run process information. When running of the sequence is to be started, the resume process information is transferred to the run process information. As a result, the resume process information and the run process information both become “normal process A”, and the sequence moves from initialization to normal process A.

When normal process A is completed, processing unit control part 4 updates the resume process information and the run process information that relate to normal process A, with corresponding information relating to next normal process B. When normal process B is completed, processing unit control part 4 updates the resume process information and the run process information that relate to normal process B, with corresponding information relating to next normal process C. When normal process C is completed, processing unit control part 4 updates the resume process information and the run process information that relate to normal process C, with corresponding information relating to next normal process D. When normal process D is completed, processing unit control part 4 updates the resume process information and the run process information that relate to normal process D, with corresponding information relating to next normal process E. When normal process E is completed, processing unit control part 4 updates the resume process information and the run process information that relate to normal process E, with corresponding information relating to the next normal process.

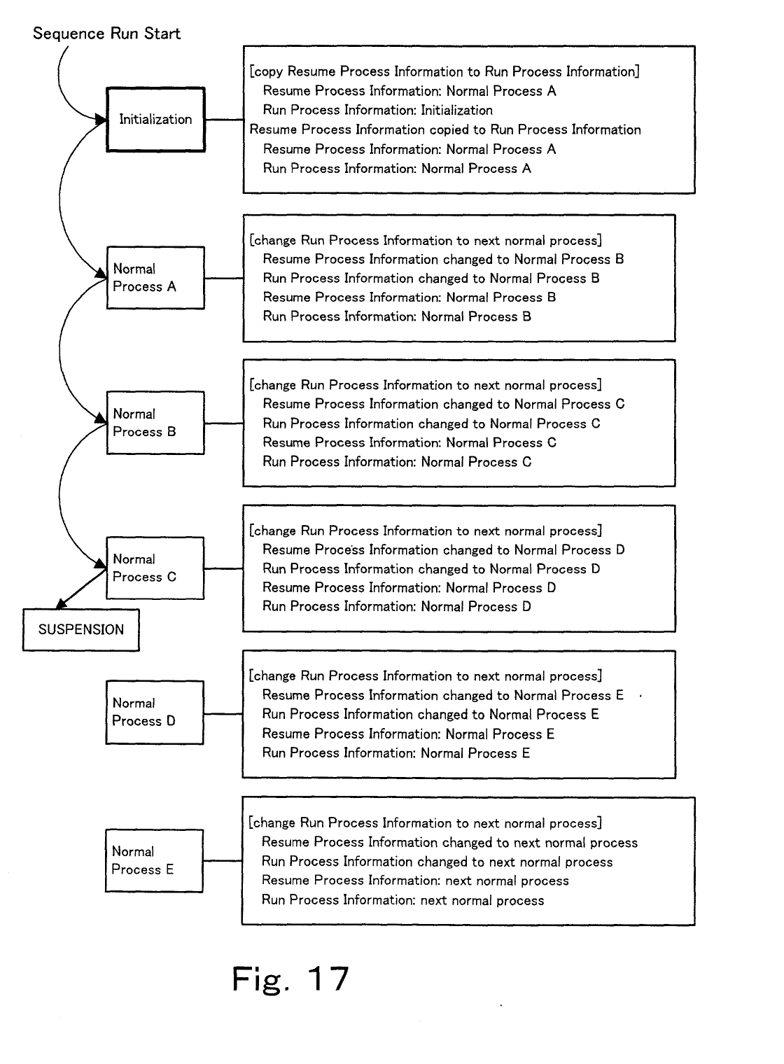

When this sequence has been suspended as shown in FIG. 17, the following are written in run process information area 10 and resume process information area 11 respectively: “resume process information: normal process D” and “run process information: normal process D”.

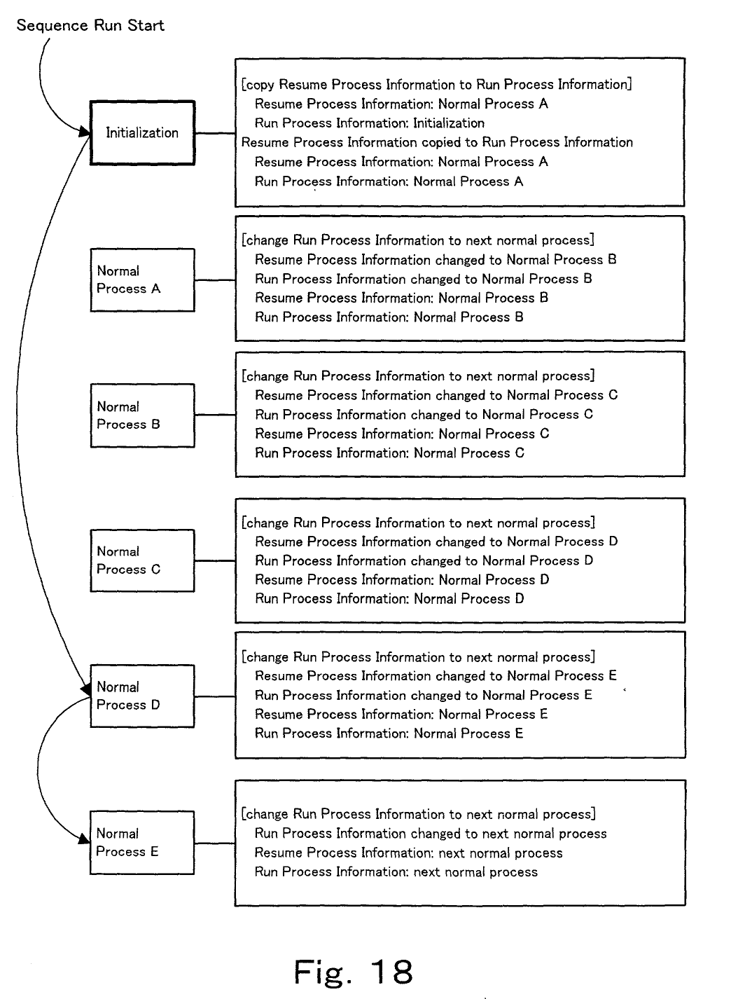

When this sequence is to be resumed after being suspended, as shown in FIG. 18, the initialization process is first of all run. Initialization is always run at the outset when a sequence is to be run, whatever the circumstances. Because in this example the processing was suspended at normal process C, the following are written in run process information area 10 and resume process information area 11 respectively: “run process information: initialization” and “resume process information: normal process D”. Transferring the run process information to the resume process information gives: “run process information: normal process D” and “resume process information: normal process D”, which means that normal process D is carried out after initialization, thereby resuming the sequence after the suspension.

This example has been described in terms of the sequence being resumed, after initialization, from normal process D. However, the processing unit at which the sequence restarts can be set as desired by rewriting the resume process information that is written in resume process information area 11. For example, in the case of a sequence consisting of normal process B for positioning a workpiece and normal process C for machining the workpiece, if the sequence has been suspended at normal process C, the control required to reconfirm whether or not the workpiece is in the correct position can easily be performed by resuming the sequence from normal process B.

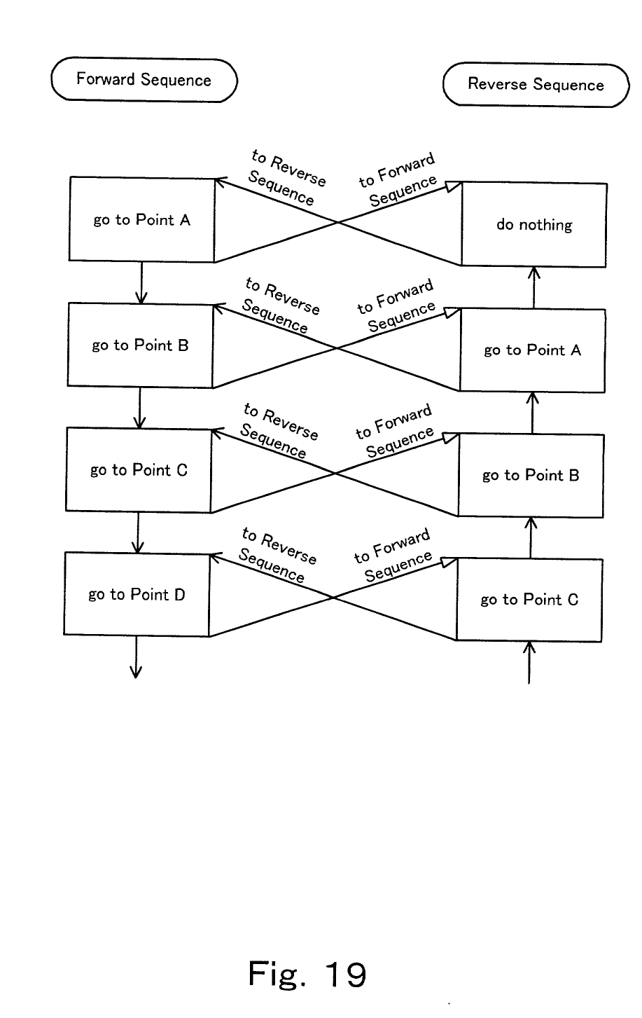

Control of sequence progression where the sequence can run both forwards and backwards will be described with reference to FIG. 19. The present invention makes it easy to implement sequence control such that, at a point in a forward running sequence, the sequence is run backwards to a position before a particular step, and then continued forwards from that step. Such control can be easily implemented as follows: when a processing unit has finished running, information specifying the processing unit to be run next is used as information relating to the reverse running direction. Such information will be called “reverse process information” and is written in reverse process information area 12 of process information storage part 2.

In the example given in FIG. 19, when the processing unit “move to point C” has been run in the forward sequence, it is possible to run a step whereby the sequence returns to point B. This is done by specifying, as the next processing unit, the processing unit “move to point B” in the reverse sequence, and this is done by means of the reverse process information.

Thus in the present invention, because a process involving movements is divided up into actions, those movements can be reversed by running those actions in reverse. Accordingly, a reverse sequence can be created by describing movements that are the opposite of those performed by the forward sequence. This enables the running direction to be shifted between forward and reverse sequences.

In the example of FIG. 19, two sequences are provided: a forward sequence which describes only the forward progression of processes involving reversible devices, and a reverse sequence comprising processes that produce movements that are the reverse of those produced by this forward sequence. Each sequence has distinguishable codes that are different for each movement-producing process, but the codes employed by the two sequences (forward and reverse) are the same. Accordingly, the movement-producing processes of the reverse sequence, which are specified by the same codes that are used by the forward sequence, can be expressed as movement-producing processes that return the position of the forward processes to a position they were in prior to movement.

As has been explained above, the present invention is readily adaptable to all sorts of control modes, including process suspend and resume, and reverse sequence control.

What is claimed is:

1. A sequence control system wherein:
a sequence program is expressed as a series of processing units, each comprising input and output of information, decisions and calculations;
for each processing unit, the processing unit to be run next is specified as run process information;
there is provided, in a memory area, a run process information area that can be looked up by all processing units, and which, each time a processing unit finishes running, is updated with the aforementioned run process information specified by that processing unit; and
there is provided means for looking up the run process information area when a processing unit finishes running, and means whereby the processing unit specified in this run process information area starts running.

2. A sequence control method comprising:
constructing a sequence program as a series of processing units, each comprising input and output of information, decisions and calculations;
specifying, for each processing unit, the processing unit to be run next; and
running this specified processing unit.

3. A recording medium in which a sequence program has been recorded, wherein:
the sequence program is divided into a plurality of processing units, each comprising a series of processes including input and output of information, decisions and calculations;
for each processing unit, the processing unit to be run next is specified as run process information; and
the sequence program runs the processing unit specified by the run process information.

4. A sequence control system according to claim 1, comprising:
in addition to run process information, resume process information for specifying the processing unit from which the sequence is to be resumed after being suspended;
a resume process information area for storing, in the aforementioned memory area, the resume process information; and
means which, when a sequence is to be resumed after that sequence has been suspended, rewrites the processing unit in the run process information area with the processing unit specified in the resume process information area, and runs the processing unit that was specified by the resume process information.

5. A sequence control method comprising:
constructing a sequence program as a series of processing units, each comprising input and output of information, decisions and calculations;
for each processing unit, in addition to specifying the processing unit to be run next as run process information, specifying the processing unit to be run after sequence suspension as resume process information; and
for normal running, running the processing unit specified by the aforementioned run process information; and for resuming after sequence suspension, running the processing unit specified by the resume process information.

6. A recording medium in which a sequence program has been recorded, wherein:
the sequence program is divided into a plurality of processing units, each comprising input and output of information, decisions and calculations;
for each such processing unit, the processing unit to be run next is specified as run process information, and additionally, the processing unit to be run after sequence suspension is specified as resume process information; and
for normal sequence running, the sequence program runs the processing unit specified by the run process information, and for resuming after sequence suspension, the sequence program runs the processing unit specified by the resume process information.

7. A sequence control system according to claim 1, comprising:
a reverse sequence program for running a sequence that is the reverse of a given sequence;
reverse process information for specifying a processing unit of the aforementioned reverse sequence program when running a reverse sequence;
a reverse process information area for storing, in the aforementioned memory area, reverse process information for specifying a processing unit when running the aforementioned reverse sequence; and
means for running the reverse sequence processing unit specified in the reverse process information area, when running the given sequence in reverse.

8. A sequence control method comprising:
dividing a sequence program into a plurality of processing units, each comprising input and output of information, decisions and calculations;
for each such processing unit, in addition to specifying the processing unit to be run next in normal sequence processing, including reverse process information for specifying the next processing unit when running a sequence in the opposite direction to normal running; and
in normal sequence running, running the processing unit specified by the run process information, and when running the reverse sequence, running the reverse sequence processing unit that is specified by the reverse process information.

9. A recording medium in which a sequence program has been recorded, wherein:
the sequence program is divided into a plurality of processing units, each comprising input and output of information, decisions and calculations;
for each such processing unit, the processing unit to be run next in normal sequence processing is specified, and there is also provided a reverse sequence in which is specified the next processing unit when running a sequence in the opposite direction to normal running; and
in normal sequence running, the sequence program runs the processing unit specified by the run process information, and when running the reverse sequence, the sequence program runs the reverse sequence processing unit specified by the reverse process information.
